(19) United States
(12) Patent Application Publication
(10) Pub. No.: US 2025/0247484 A1
(43) Pub. Date: Jul. 31, 2025

(54) INFORMATION PROCESSING SYSTEM THAT CUTS MEDIUM TO BE CUT, STORAGE MEDIUM STORING CUTTING APPLICATION, AND IMAGE FORMING APPARATUS

(71) Applicant: CANON KABUSHIKI KAISHA, Tokyo (JP)

(72) Inventor: CHIE ITO, Chiba (JP)

(21) Appl. No.: 18/985,728

(22) Filed: Dec. 18, 2024

(30) Foreign Application Priority Data
Jan. 29, 2024 (JP) 2024-010797

(51) Int. Cl. H04N 1/387; H04N 1/00

(52) U.S. Cl. CPC H04N 1/3873; H04N 1/00676

(57) ABSTRACT

An information processing system capable of saving a recording material used for printing a medium to be cut using a cutting machine. The information processing system includes an image forming apparatus configured to print a print image on a medium, an information processing apparatus, and a cutting machine. The information processing system comprises at least one memory and at least one processor which function as a setting unit configured to set a cutting region in which the cutting machine cuts the medium on which the print image has been printed, and a print image generation unit configured to generate, from an input image, the print image not including an image outside a cutting region.

### BACKGROUND OF THE INVENTION

### Field of the Invention

The present invention relates to an information processing system, a storage medium storing a cutting application, and an image forming apparatus, and more particularly to an information processing system that cuts a medium to be cut, a storage medium storing a cutting application, and an image forming apparatus.

### Description of the Related Art

Currently, a device, which is called a cutting machine that cuts a medium to be cut, such as paper or cloth, is widely used. In a retail store, a school, and the like, there is a use case in which an image is printed on a medium to be cut using an image forming apparatus, and then the medium after printing is cut using a cutting machine.

For example, there is known a conventional technique of giving a cutting line to an image of a printed object such as a photograph, a character, a picture, or a pattern to be printed on a medium to be cut (for example, Japanese Patent No. 4534823).

However, a cuttable region exists in the cutting machine. Therefore, when an image is printed on the medium to be cut using the image forming apparatus, there is a case where the image is printed outside the cuttable region of the medium. In this case, the image outside the cuttable region does not become the image to be cut, and thus even if the image is printed on the medium, the image is discarded after cutting, and is wasted. In addition, in a case where the image to be cut is small with respect to the image printed on the medium, most of the image printed on the medium is discarded after cutting, and is wasted. In particular, in a case where there is a large number of mediums to be cut, or in a case where an image to be printed on the medium requires a large amount of recording materials such as toner and ink, these wastes become very large.

### SUMMARY OF THE INVENTION

The present invention has been made in view of at least one of the above problems, and the present invention provides an information processing system, a storage medium storing a cutting application, and an image forming apparatus capable of saving a recording material used for printing a medium to be cut using a cutting machine.

Accordingly, the present invention provides an information processing system including an image forming apparatus configured to print a print image on a medium, an information processing apparatus, and a cutting machine, the information processing system comprising at least one memory and at least one processor which function as a setting unit configured to set a cutting region in which the cutting machine cuts the medium on which the print image has been printed, and a print image generation unit configured to generate, from an input image, the print image not including an image outside a cutting region . . .

Accordingly, the present invention provides a non-transitory computer readable storage medium storing a cutting application that causes an information processing apparatus to cooperates with an image forming apparatus configured to print a print image on a medium and a cutting machine, the cutting application comprising code for executing setting of a cutting region in which the cutting machine cuts the medium on which the print image has been printed, and generating of the print image not including an image outside a cutting region from an input image.

Accordingly, the present invention provides an image forming apparatus connected to an information processing apparatus and a cutting machine and configured to print a print image on a medium, the image forming apparatus comprising at least one memory and at least one processor which function as an acquisition unit configured to acquire, from the information processing apparatus, a cutting region in which the cutting machine cuts a medium on which the print image has been printed, and a print image generation unit configured to generate, from an input image, the print image not including an image outside a cutting region.

### BRIEF DESCRIPTION OF THE DRAWINGS

FIG. 1 is a block diagram showing an example of an overall configuration of an information processing system according to an embodiment of the present invention.

FIG. 2 is a block diagram showing a hardware configuration example of an image forming apparatus in FIG. 1.

FIG. 3 is a block diagram showing a software configuration example of an OS of the image forming apparatus.

FIG. 4 is a block diagram showing a hardware configuration example of a cutting machine in FIG. 1.

FIG. 5 is a block diagram showing a software configuration example of the cutting machine.

FIG. 6 is a block diagram showing a hardware configuration example of an information processing apparatus in FIG. 1.

FIG. 7 is a block diagram showing a software configuration example of a cutting application stored in a storage in FIG. 6.

FIG. 8 is an example of a sequence of a series of processing until a target to be cut is printed by the image forming apparatus and cutting is performed by the cutting machine.

FIG. 9 is a variation of a sequence of a series of processing until a target to be cut is printed by the image forming apparatus and cutting of the target is performed by the cutting machine.

FIGS. 10A to 10F are diagrams showing an example of an image to be cut, an output object output as it is without trimming the image to be cut, and an output object when the image to be cut is trimmed.

FIG. 11A is an example of a flowchart of processing executed by the cutting application when an image to be cut is printed.

FIG. 11B is a continuation of FIG. 11A.

FIG. 12 is an example of a flowchart of processing executed by the image forming apparatus when printing the target to be cut.

FIG. 13 is a diagram showing an example of a trimming setting screen.

FIG. 14A is a diagram showing an example of a setting screen displayed in the processing of step S1103 in FIG. 11A.

FIG. 14B is a diagram showing an example of a preview screen displayed in the processing of step S1104 in FIG. 11A.

FIG. 14C is a diagram showing an example of a setting screen redisplayed in the processing of step S1106 in FIG. 11A.

### DESCRIPTION OF THE EMBODIMENTS

The present invention will now be described in detail below with reference to the accompanying drawings showing embodiments thereof.

The scope of the present invention is not limited to the configurations described in the embodiments. Modifications such as replacement or omission of a part of the configuration or a part of the processing with equivalents may be made as long as a similar effect can be obtained.

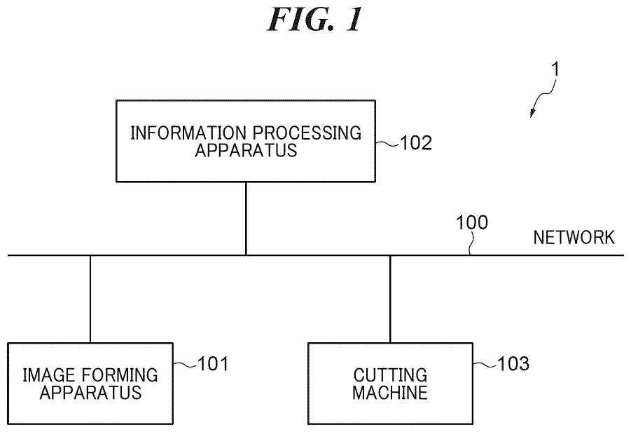

FIG. 1 is a block diagram showing an overall configuration of an information processing system 1 according to an embodiment of the present invention.

In FIG. 1, the information processing system 1 includes an image forming apparatus 101, an information processing apparatus 102, and a cutting machine 103, which are communicably connected via a network 100.

The image forming apparatus 101 receives an instruction from the information processing apparatus 102 and prints an image including a target to be cut on a medium to be cut. The cutting machine 103 receives an instruction from the information processing apparatus 102, and cuts the printed medium output from the image forming apparatus 101 on the basis of the designated cutting information.

In the present embodiment, the information processing apparatus 102 is configured to issue an instruction to each of the image forming apparatus 101 and the cutting machine 103, but the present invention is not limited thereto. For example, the image forming apparatus 101 that has received an instruction from the information processing apparatus 102 may perform a series of processing from printing to cutting in cooperation with the cutting machine 103.

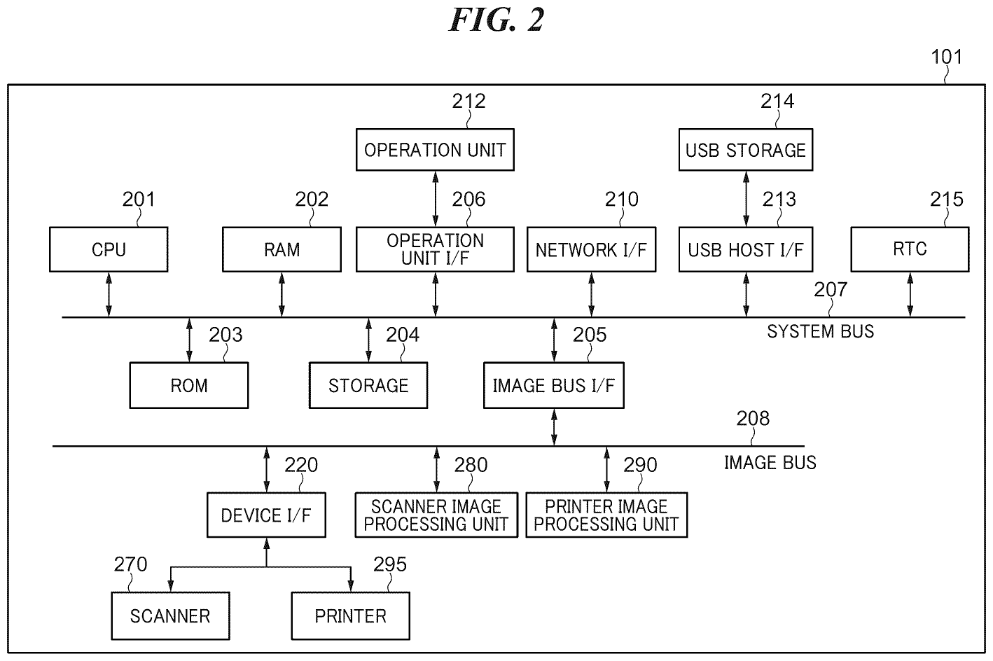

FIG. 2 is a block diagram showing a hardware configuration of the image forming apparatus 101.

The image forming apparatus 101 includes a CPU 201, a RAM 202, a ROM 203, a storage 204, an image bus interface (I/F) 205, an operation unit I/F 206, a system bus 207, an image bus 208, a network I/F 210, and an operation unit 212. The image forming apparatus 101 further includes a USB host I/F 213, a USB storage 214, an RTC 215, a device I/F 220, a scanner 270, a scanner image processing unit 280, a printer image processing unit 290, and a printer 295.

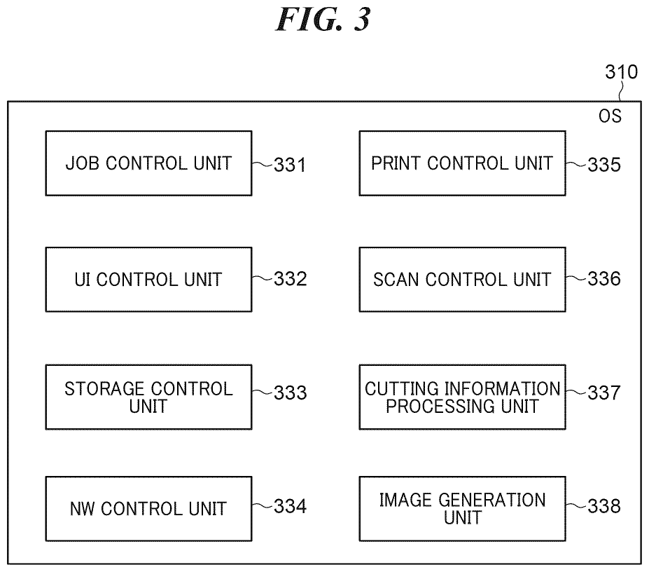

The CPU 201 starts up an operation system (OS) 310 (FIG. 3) by a boot program stored in the ROM 203. The CPU 201 executes a program stored in the storage 204 on the OS 310, thereby executing various types of processing. The RAM 202 is used as a work area of the CPU 201. The RAM 202 provides the work area and also provides an image memory area for temporarily storing image data. The storage 204 stores programs and image data.

The ROM 203, the RAM 202, the storage 204, the operation unit I/F 206, the network I/F 210, the USB host I/F 213, the RTC 215, and the image bus I/F 205 are connected to the CPU 201 via the system bus 207. The operation unit I/F 206 is an interface with the operation unit 212 having a touch panel, and outputs image data to be displayed on the operation unit 212 to the operation unit 212. In addition, the operation unit I/F 206 sends information input by a user in the operation unit 212 to the CPU 201. The network I/F 210 is an interface for communicating with the information processing apparatus 102 and the cutting machine 103 via the network 100 (FIG. 1) (not illustrated in FIG. 2).

The USB host I/F 213 is an interface unit that communicates with the USB storage 214. The USB host I/F 213 is an output unit for storing data stored in the storage 204 in the USB storage 214. In addition, the USB host I/F 213 inputs data stored in the USB storage 214 and transmits the data to the CPU 201. The USB storage 214 is a storage device that stores data, and is detachable from the USB host I/F 213. A plurality of USB devices including the USB storage 214 can be connected to the USB host I/F 213.

The RTC 215 controls the current time. The time information controlled by the RTC 215 is used for recording job input time or the like.

The image bus I/F 205 is a bus bridge that connects the system bus 207 and the image bus 208 that transfers image data at a high speed and converts a data format. The device I/F 220, the scanner image processing unit 280, and the printer image processing unit 290 are provided on the image bus 208. The scanner 270 and the printer 295 are connected to the device I/F 220, and the device I/F 220 performs synchronous/asynchronous conversion of image data. When a scanned image from the scanner 270 is input, the scanner image processing unit 280 performs correction, processing, and editing on the input scanned image data. The printer image processing unit 290 performs correction, resolution conversion, and the like on the image data for print output, according to the printer 295.

FIG. 3 is a block diagram showing a software configuration of the OS 310 of the image forming apparatus 101.

As shown in FIG. 3, the OS 310 includes a job control unit 331, a UI control unit 332, a storage control unit 333, an NW control unit 334, a print control unit 335, a scan control unit 336, a cutting information processing unit 337, and an image generation unit 338. Each of these modules is a software module realized by the CPU 201 executing a main program loaded in the RAM 202, and the execution thereof is managed and controlled by the CPU 201.

The UI control unit 332 displays a screen on the operation unit 212 and receives an operation from the user through the operation unit I/F 206. In addition, the UI control unit 332 has a function of notifying another module included in the OS 310 and controlling screen update of the operation unit 212 in response to a drawing instruction from the another module.

The job control unit 331 is a module that controls job processing such as copying, scanning, and printing in response to a job execution instruction from the NW control unit 334 or the UI control unit 332.

The NW control unit 334 receives a communication request from another module, controls the network I/F 210, and controls communication with an external device. In addition, upon receipt of a notification from the external device, the NW control unit 334 notifies the another module of the notification content. The storage control unit 333 records and manages setting information and job information recorded in the storage 204. Each module located in the hierarchy of the OS accesses the storage control unit 333, and refers to and sets a setting value.

The print control unit 335 controls the printer 295 via the device I/F 220 to execute printing in cooperation with the printer image processing unit 290.

The scan control unit 336 controls the scanner 270 via the device I/F 220 to execute scanning in cooperation with the scanner image processing unit 280.

The cutting information processing unit 337 manages information on a cuttable region of the cutting machine 103 and a cutting region on the print image in cooperation with the information processing apparatus 102 and the cutting machine 103 via the network I/F 210.

In response to an instruction from the job control unit 331, the image generation unit 338 generates an image corresponding to the job in cooperation with the printer image processing unit 290 and the scanner image processing unit 280.

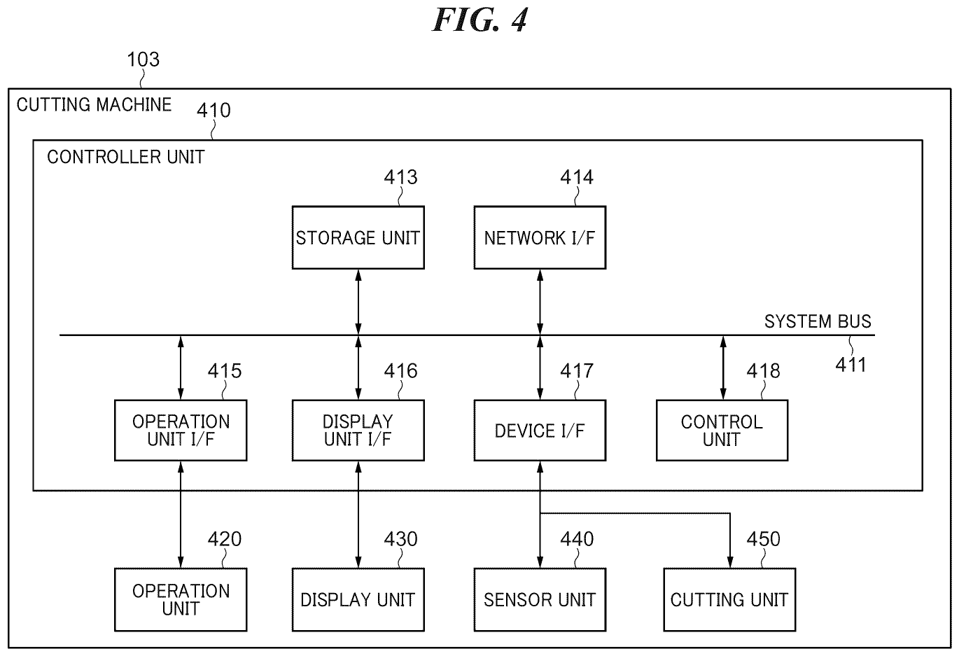

FIG. 4 is a block diagram showing a hardware configuration of the cutting machine 103.

The cutting machine 103 includes a controller unit 410, an operation unit 420, a display unit 430, a sensor unit 440, and a cutting unit 450 as main components.

The controller unit 410 includes a storage unit 413, a network I/F 414, an operation unit I/F 415, a display unit I/F 416, a device I/F 417, and a control unit 418 connected to each other via a system bus 411.

The control unit 418 includes a CPU, and realizes a function of the cutting machine 103 by executing a command of a control program stored in the storage unit 413.

The storage unit 413 includes a ROM, a RAM, an HDD, and the like, and stores various data such as cut setting and position information in addition to the control program. The storage unit 413 may further include an external storage device such as a USB memory or an external hard disk.

The network I/F 414 is an interface for communicating with the information processing apparatus 102 and the image forming apparatus 101 via the network 100 (FIG. 1) (not shown in FIG. 4).

The operation unit I/F 415 sends, to the control unit 418, information input by the user in the operation unit 420. The operation unit 420 is an input device including a cursor key and a decision key for receiving a user's input operation.

The display unit I/F 416 is an interface with the display unit 430, and outputs image data to be displayed on the display unit 430 to the display unit 430. The display unit 430 is a display device such as a liquid crystal panel for displaying information such as cut setting to the user.

The device I/F 417 is an interface with the sensor unit 440 and the cutting unit 450, sends the image data acquired by the sensor unit 440 to the control unit 418, and sends the control information from the control unit 418 to the cutting unit 450. The sensor unit 440 is a device for detecting a trim mark on a cutting object medium on the basis of a sensor output and scanning the cutting object medium to acquire the scanned result as image data. The cutting unit 450 is a device including a cutter for cutting the cutting object medium, a drive roller for moving the cutter, and a conveyance mechanism for moving the cutting object medium.

The operation of each device of the operation unit 420, the display unit 430, the sensor unit 440, and the cutting unit 450 is controlled by a control signal transmitted from the control unit 418.

In order to realize cutting processing by the cutting machine 103, specifically, the following processing is executed. First, in response to signals received from the operation unit 420, the sensor unit 440, and the network I/F 414, a control signal is transmitted from the control unit 418 to the cutting unit 450. Next, in response to the control signal from the control unit 418, the cutting unit 450 operates the internal conveyance mechanism and the drive roller to move the cutter. By such control, a predetermined cut line can be formed on the cutting object medium.

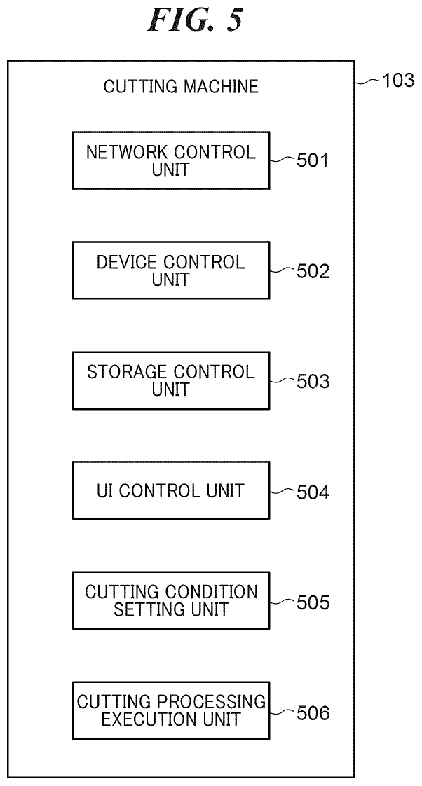

FIG. 5 is a block diagram showing a software configuration of the cutting machine 103.

As illustrated in FIG. 5, the software of the cutting machine 103 includes a network control unit 501, a device control unit 502, a storage control unit 503, a UI control unit 504, a cutting condition setting unit 505, and a cutting processing execution unit 506 as main modules. These modules are implemented by the control unit 418 executing the control program.

The network control unit 501 is a module for controlling a plurality of communication protocols supported by the cutting machine 103 via the network I/F 414.

The device control unit 502 is a module for controlling the sensor unit 440 and the cutting unit 450 via the device I/F 417.

The storage control unit 503 is a module for managing and controlling memory access of the storage unit 413.

The UI control unit 504 is a module for controlling the operation unit 420 and the display unit 430 via the operation unit I/F 415 and the display unit I/F 416.

The cutting condition setting unit 505 is a module for receiving cutting setting information from at least one of the operation unit I/F 415 and the network I/F 414, and updating and storing data in the storage unit 413.

The cutting processing execution unit 506 is a module for receiving a cutting execution signal from the operation unit I/F 415 and the network I/F 414 and controlling the cutting unit 450 according to the cutting setting information.

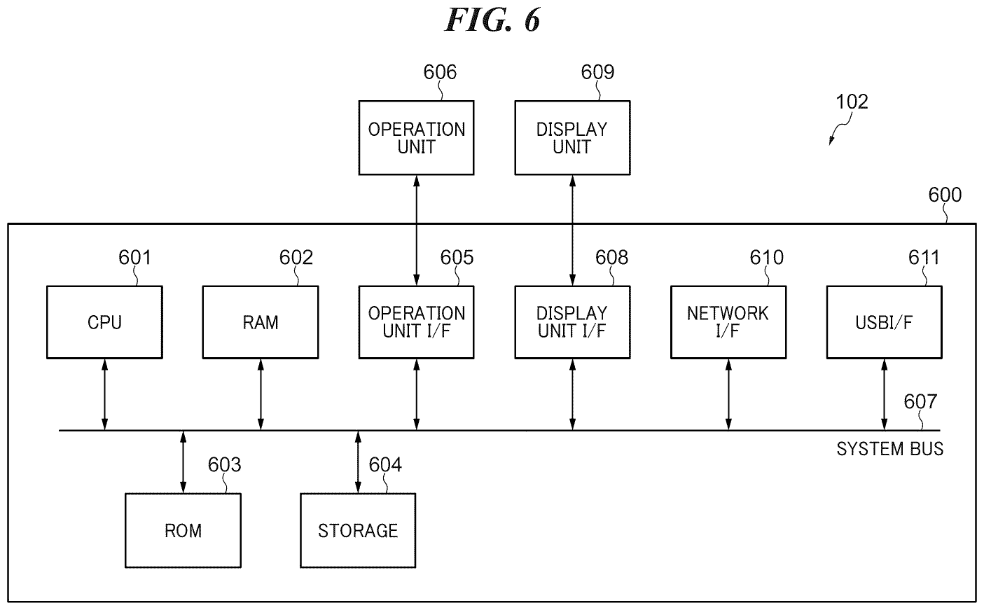

FIG. 6 is a block diagram illustrating a hardware configuration of the information processing apparatus 102.

The information processing apparatus 102 includes a controller unit 600, an operation unit 606, and a display unit 609 as main components.

The controller unit 600 includes a CPU 601, a RAM 602, a ROM 603, a storage 604, an operation unit I/F 605, a display unit I/F 608, a network I/F 610, and a USB I/F 611 connected to each other via a system bus 607.

The CPU 601 reads a control program stored in the ROM 603 or the storage 604 and controls the function of the information processing apparatus 102. The RAM 602 is a main storage memory of the CPU 601, and is used as a temporary storage area for developing various control programs stored in the ROM 603 and the storage 604. The ROM 603 stores the control program that can be executed by the CPU 601. The storage 604 is a storage device such as an SSD or an HDD, and stores image data and an application program. The operation unit I/F 605 connects the operation unit 606 and the controller unit 600. The operation unit 606 is a device for detecting an input from the user, and includes a mouse, a keyboard, and the like. The display unit I/F 608 connects the display unit 609 and the controller unit 600. The display unit 609 is a device for displaying processing contents of the information processing apparatus 102 so that the user can grasp the processing contents, and includes a liquid crystal monitor in the present embodiment. The network I/F 610 is an interface for communicating with the image forming apparatus 101 and the cutting machine 103 via the network 100 (FIG. 1) (not illustrated in FIG. 6). The USB I/F 611 transmits and receives data to and from an external device via a USB standard cable. The operation unit 606 may be connected to the information processing apparatus 102 via the USB I/F 611. The system bus 607 mediates exchange of data of each unit.

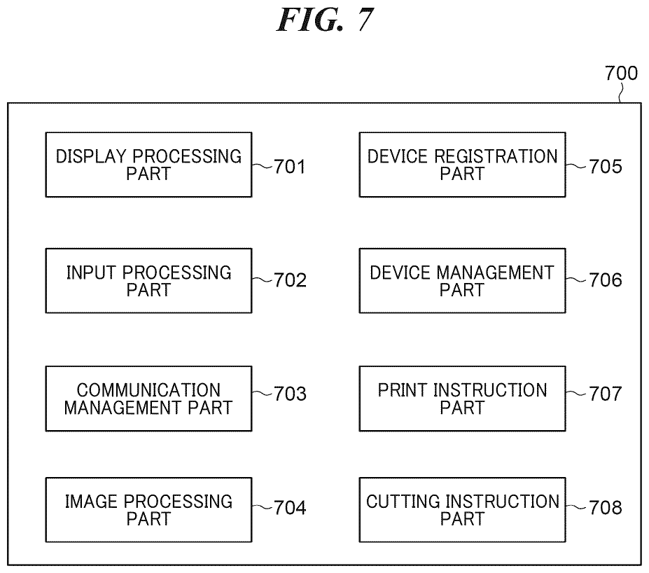

FIG. 7 is a block diagram showing a software configuration of a cutting application 700 (hereinafter, simply referred to as a cutting app 700). The cutting app 700 is stored in the storage 604 of the information processing apparatus 102 and cooperates with the image forming apparatus 101 and the cutting machine 103.

As shown in FIG. 7, the cutting app 700 includes a display processing part 701, an input processing part 702, a communication management part 703, an image processing part 704, a device registration part 705, a device management part 706, a print instruction part 707, and a cutting instruction part 708 as main functional parts.

The display processing part 701 controls contents to be displayed on the display unit 609 when the cutting app 700 is executed. The input processing part 702 detects an input from the operation unit 606 while the cutting app 700 is being executed, and transmits data to another functional part. The communication management part 703 controls communication with the image forming apparatus 101 and the cutting machine 103 via the network I/F 610. On the basis of a user operation input from the input processing part 702, the image processing part 704 generates image data with trim mark based on an image file and generates print data and cutting data. The device registration part 705 detects the image forming apparatus 101 and the cutting machine 103, which are devices connected via the network I/F 610 and the USB I/F 511, and stores information of the detected devices in the storage 604. The information of the device stored here includes the type of the device and the communication information. The device management part 706 updates or deletes the information of the device registered by the device registration part 705. In the present embodiment, the device registration part 705 and the device management part 706 are included in the cutting app 700, but these functions may be realized by cooperating with driver software (not illustrated) stored in the storage 604 of the information processing apparatus 102. On the basis of a user operation input from the input processing part 702, the print instruction part 707 transmits print data and cutting data to the image forming apparatus 101. In this transmission, the communication information of the device managed by the device management part 706 is used. The cutting instruction part 708 transmits cutting data to the cutting machine 103 on the basis of a user operation input from the input processing part 702. In this transmission, the communication information of the device managed by the device management part 706 is used.

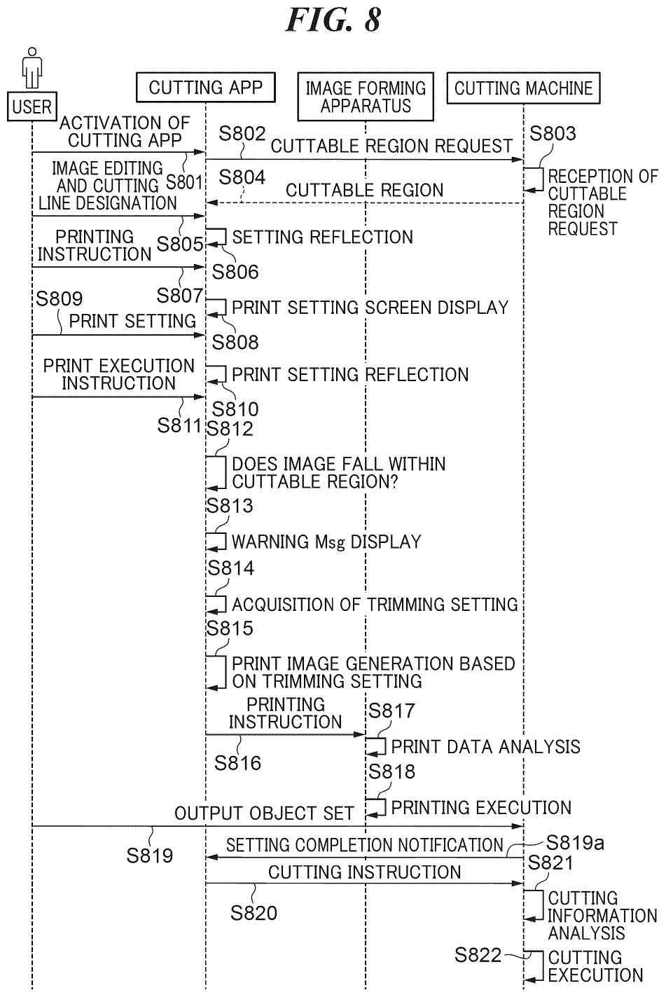

FIG. 8 is an example of a sequence of a series of processing until an image to be cut is printed by the image forming apparatus 101 and cutting is performed by the cutting machine 103. In the present use case, trimming of a print image and generation of an image to be cut are performed by the cutting app 700 according to setting of trimming to be described later.

When the cutting app 700 is activated by a user operation on the operation unit 606 of the information processing apparatus 102 (step S801), the processing proceeds to step S802.

In step S802, the device registration part 705 of the cutting app 700 detects the cutting machine 103, and requests the detected cutting machine 103 for device information including information of the cuttable region.

Thereafter, upon receiving the device information request including the cuttable region (step S803), the control unit 418 of the cutting machine 103 transmits its own ability information including the cuttable region to the cutting app 700 (step S804). As long as the device information of the cutting machine 103 can be acquired, the cutting app 700 does not need to request the device information from the detected cutting machine 103 as in the present embodiment. For example, if the information of the cutting machine 103 is included in the device information already registered in the device management part 706, the registered device information may be used without making the request in step 802.

Next, in the cutting app 700, processing from steps S805 to S816 is performed.

First, the display processing part 701 displays a preview screen for the user to perform settings such as insertion of an image to be cut and designation of a cutting region and a cutting line, and the input processing part 702 receives the user-input setting based on the preview screen (step S805). The input processing part 702 transmits data of each setting input by the user to the image processing part 704 and the like, and each functional part to which the data is transmitted reflects the setting input by the user (step S806).

Next, when the input processing part 702 receives the user input of a print instruction of the inserted image to be cut (step S807), the display processing part 701 displays a print setting screen (not illustrated) (step S808).

Thereafter, when the input processing part 702 receives the user input of print settings such as selection of paper to be printed, presence or absence of printing of a trim mark image, and selection of a paper feed tray of the image forming apparatus 101 on the basis of the print setting screen (step S809), the processing proceeds to step S810.

In step S810, in cooperation with the image processing part 704 and the print instruction part 707, the input processing part 702 reflects the print setting input by the user to each functional part.

Thereafter, when the input processing part 702 receives the user input of a print execution instruction (step S811), the processing proceeds to step S812.

In step S812, the image processing part 704 checks whether or not the image to be printed falls within the cuttable region of the cutting machine 103. If the image does not fall within the cuttable region (NO in step S812), the display processing part 701 displays a warning message (step S813). “Continue printing as it is” and “return to image editing” are displayed as warning message in a user-selectable manner. In the present use case, a case where “return to image editing” is selected by the user on the basis of the warning message by the operation unit 606, and the user edits the image so that the image falls within the cuttable region will be described. Although not illustrated in this sequence, if the image falls within the cuttable region (YES in step S812) or if “continue printing as it is” is selected by the user on the basis of the warning message by the operation unit 606, the processing directly proceeds to step S816 to be described later.

Next, when acquiring the trimming setting stored in the storage 604 (step S814), the image processing part 704 generates the trimmed print image according to the acquired trimming setting (step S815). Here, the trimmed print image is an image generated based on the image of the input image data, and is an image that does not include an image outside of the cutting line set by the user. Alternatively, the image is an image generated based on the image of the input image data, and is an image that does not include an image outside of the cuttable region of the cutting machine.

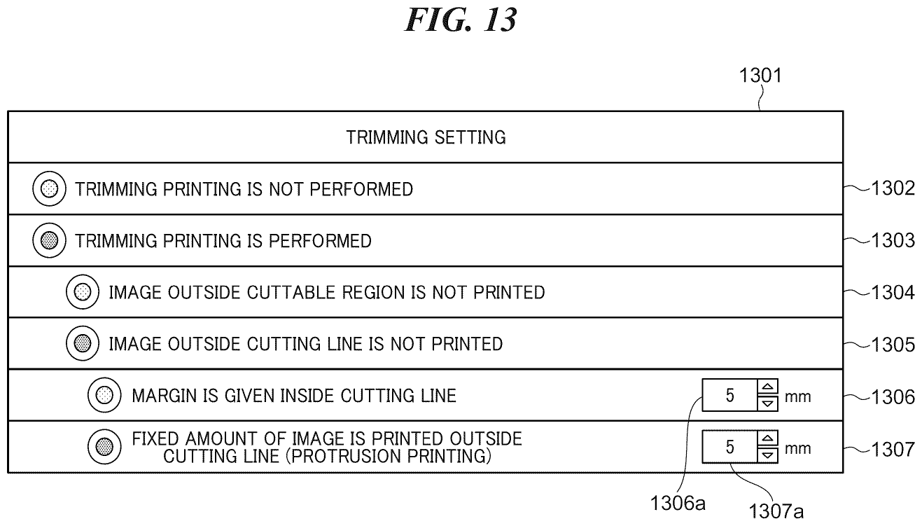

Thereafter, the processing proceeds to step S816. The trimming setting is a setting related to printing of an image to be cut, and will be described in detail later with reference to FIG. 13.

In step S816, the image processing part 704 generates print data on the basis of the generated print image, and transmits a print execution instruction to the image forming apparatus 101 together with the print data. In the image forming apparatus 101, the CPU 201 analyzes the received print data (step S817), performs image processing or the like based on the analysis result, and then executes printing (step S818). As a result, the trimmed print image generated in step S815 is printed on the paper selected by the user in step S809, and the obtained printed matter is output from the image forming apparatus 101.

When the printed matter obtained in step S818 is set at a predetermined position by the user (step S819), the cutting machine 103 transmits a setting completion notification of the printed matter to be cut to the cutting app 700 (step S819a).

Upon receiving the setting completion notification, the cutting instruction part 708 of the cutting app 700 transmits cutting information including cutting data to the cutting machine 103 to issue a cutting instruction (step S820). In the present embodiment, the cutting instruction is made in response to the reception of the setting completion notification, but the present invention is not limited thereto. For example, in step S819a, the setting completion notification may be displayed on the display unit 430 of the cutting machine 103. In this case, in step S820, in a case where the operation unit 420 receives the cutting instruction from the user, the cutting instruction part 708 issues the cutting instruction to the cutting machine 103.

The cutting machine 103 receives the cutting instruction, analyzes the cutting data included in the received cutting instruction (step S821), and executes cutting of the printed matter to be cut (step S822).

Thus, the processing of the sequence of FIG. 8 ends.

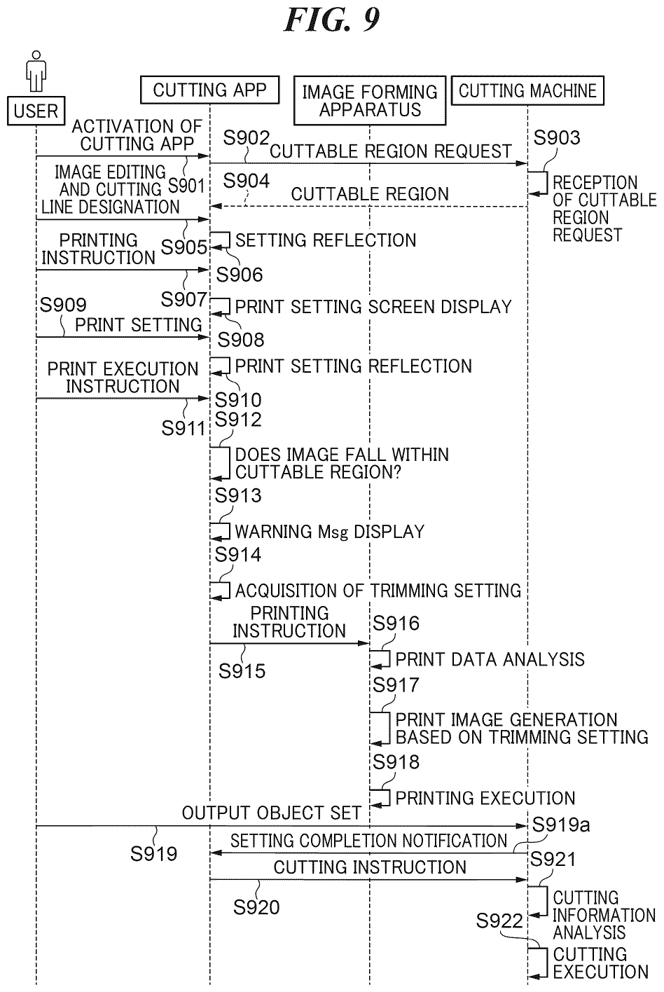

FIG. 9 is a variation of a sequence of a series of processing until an image to be cut is printed by the image forming apparatus 101 and cutting is performed by the cutting machine 103. In the present use case, trimming of a print image and generation of an image to be cut are performed by the image forming apparatus 101 according to setting of trimming to be described later.

When the cutting app 700 is activated by the user operation in the information processing apparatus 102, the cutting app 700 performs the processing from steps S901 to S914 of acquiring the print execution instruction from the user and the trimming setting, and then the processing proceeds to step S915. It should be noted that the processing in steps S901 to S914 is similar to the processing in steps S801 to S814 in FIG. 8, and thus the detailed description of these processing will be omitted.

In step S915, the image processing part 704 transmits a print execution instruction to the image forming apparatus 101 together with the image to be cut, the cuttable region, and the trimming setting (step S915). In the image forming apparatus 101 that has received the print execution instruction, the CPU 201 analyzes the received image data to be cut, cuttable region, and trimming setting (step S916). Thereafter, on the basis of the analysis result in step S916, the CPU 201 generates trimmed print data (step S917), and then executes printing (step S918). As a result, the trimmed print data generated in step S917 is printed on the paper selected by the user in step S909, and the obtained printed matter is output from the image forming apparatus 101.

Next, the processing of steps S919 to S922, which is the processing on the obtained printed matter, is executed, and the sequence of FIG. 9 ends. It should be noted that the processing in steps S919 to S922 is similar to the processing in steps S819 to S822 in FIG. 8, and thus the detailed description of these processing will be omitted.

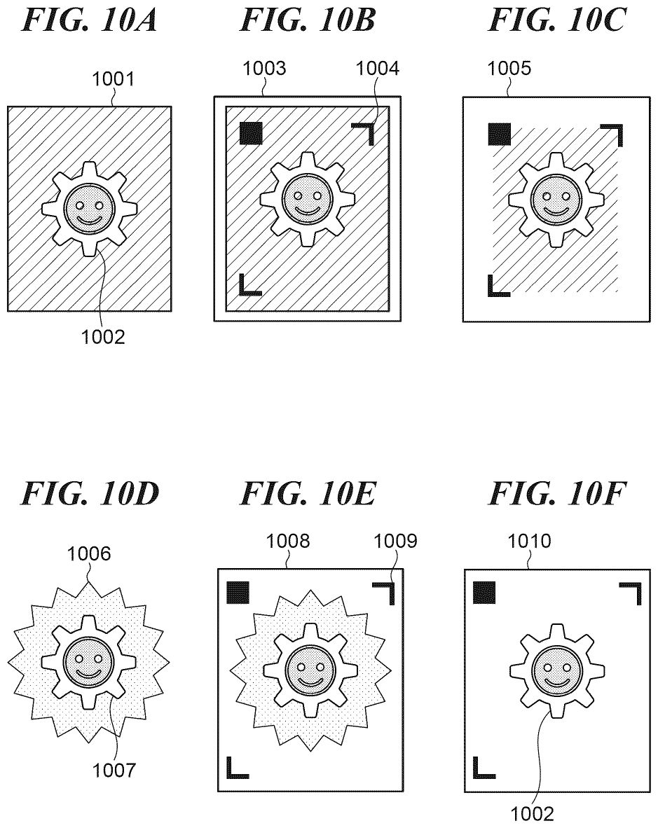

FIGS. 10A to 10F are diagrams showing examples of an image to be cut, an output object output as it is without trimming the image to be cut, and an output object when the image to be cut is trimmed.

FIG. 10A is a diagram showing an image 1001 to be printed selected by the user. In this example, the user designates the cutting region with a cutting line 1002 shown in FIG. 10A.

FIG. 10B is a diagram showing an output object 1003 when the image 1001 is printed as it is without being trimmed and output. The cuttable region is a rectangular region surrounded by a trim mark image 1004 that is read by the cutting machine 103 and printed on the output object 1003 for use for alignment.

FIG. 10C is a diagram showing an output object 1005 in a case where the trimming setting, which will be described later with reference to FIG. 13, for the image 1001 is “an image outside cuttable region is not printed”. As compared with the output object 1003 without being trimmed, in the output object 1005, printing of an image outside the cuttable region is omitted, so that consumption of toner can be reduced.

FIG. 10D is a diagram showing an image 1006 to be printed selected by the user. In this example, the user designates the cutting region with a cutting line 1007 shown in FIG. 10D.

FIG. 10E is a diagram showing an output object 1008 when the image 1006 is printed as it is without being trimmed and output.

FIG. 10F is a diagram showing an output object 1010 in a case where the trimming setting, which will be described later with reference to FIG. 13, for the image 1006 is “an image outside cutting line is not printed”. As compared with the output object 1008 without being trimmed, printing of an image outside the cutting region designated with the cutting line 1007 is omitted, so that consumption of toner can be reduced. Even in a case where the trimming setting, which will be described later with reference to FIG. 13, for the image 1001 is “an image outside cutting line is not printed”, printing of an image outside the cutting region designated with the cutting line 1002 is omitted, and an output object similar to the output object 1010 is obtained.

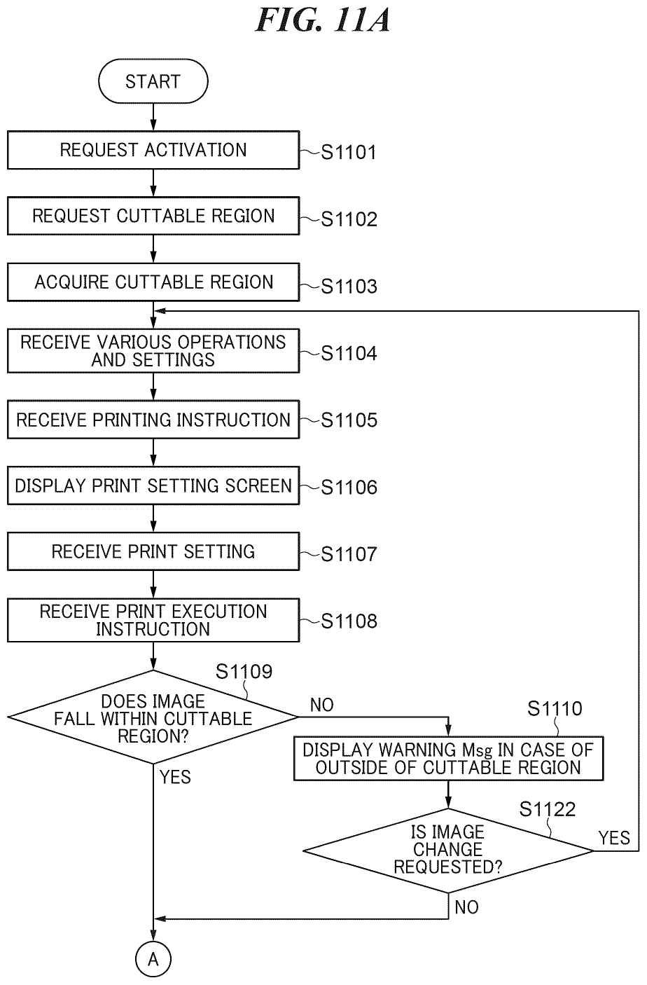

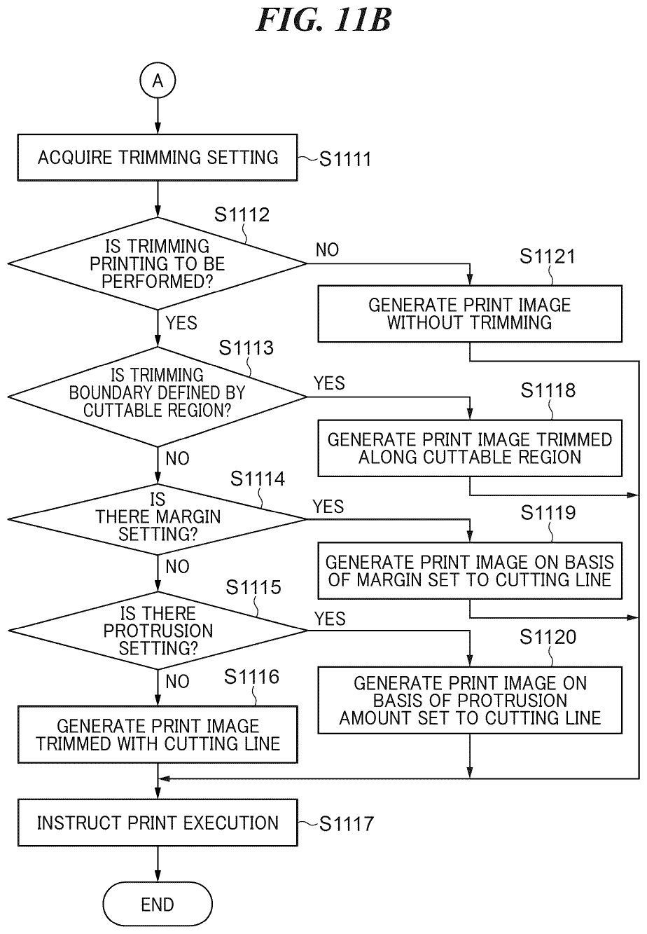

FIGS. 11A and 11B show an example of a flowchart of processing executed by the cutting app 700 when an image to be cut is printed. Here, FIGS. 11A and 11B are flowcharts for describing in more detail the processing by the cutting app 700 in the sequence of FIG. 8.

When the operation unit 606 of the information processing apparatus 102 receives a activation request of the cutting app 700 from the user (step S1101), the cutting app 700 activates, and the processing proceeds to step S1102.

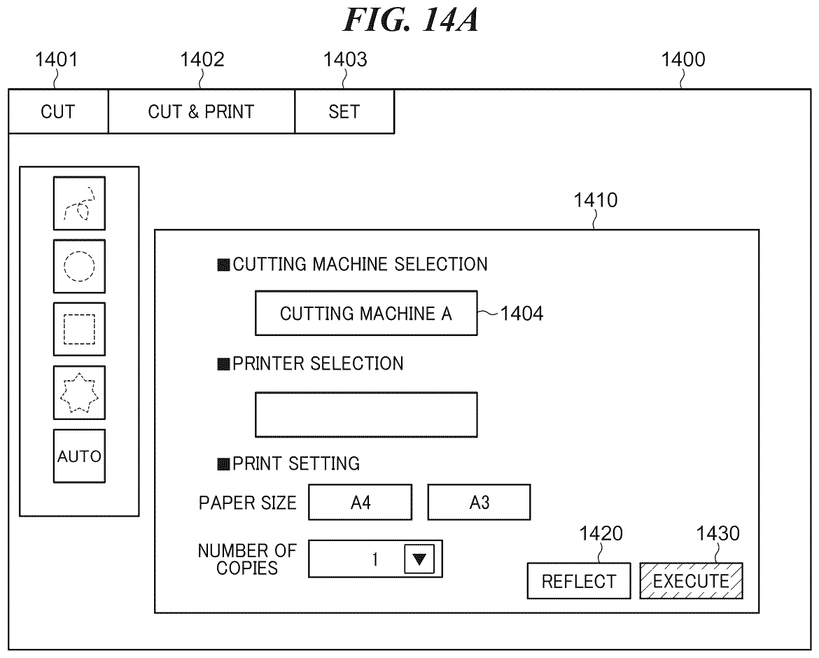

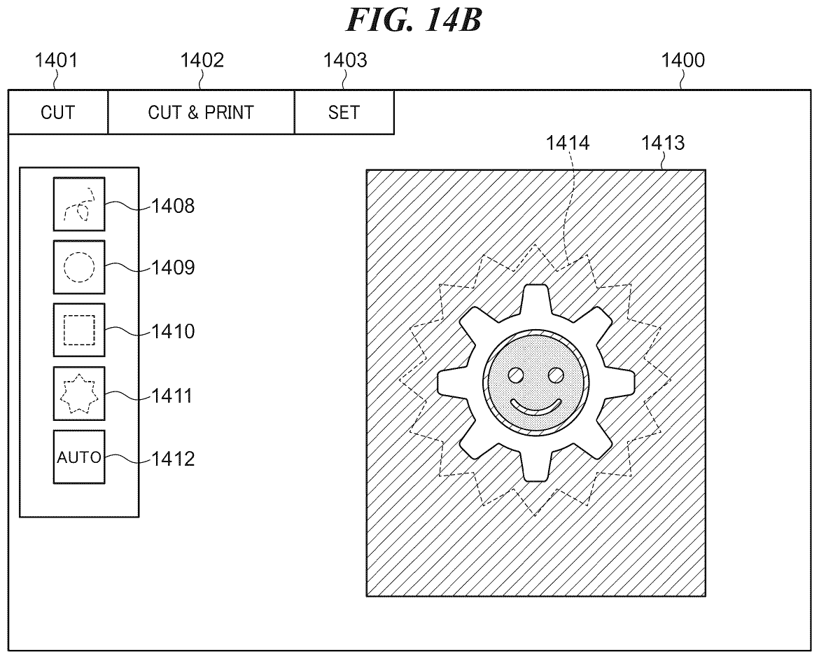

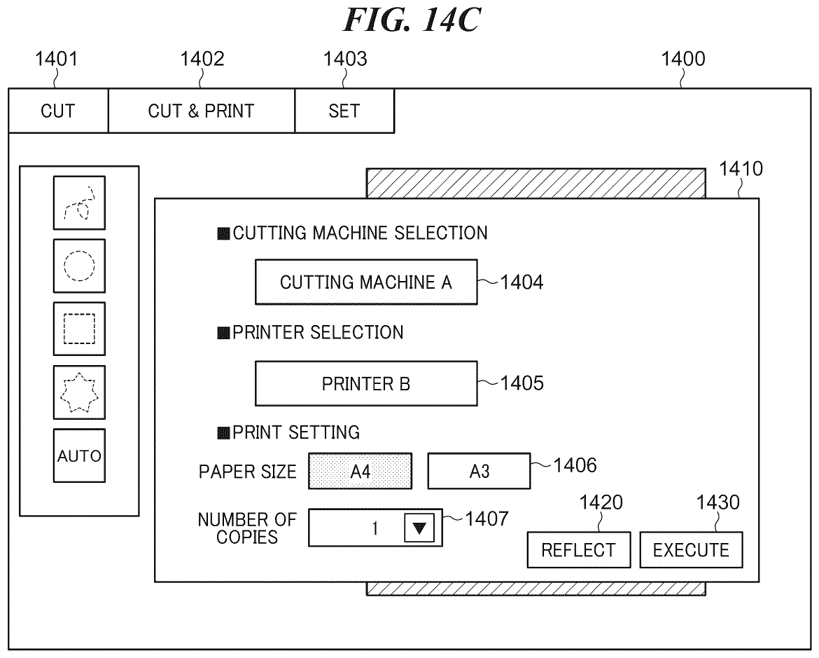

In step S1102, the device registration part 705 of the cutting app 700 detects the cutting machine 103, and requests the detected cutting machine 103 for device information including information of the cuttable region. In step S1103, in response to this request, the device registration part 705 receives the device information including the information of the cuttable region transmitted from the cutting machine 103 to acquire the information of the cuttable region (first acquisition unit). FIG. 14A shows a setting screen 1410 that the display processing part 701 of the cutting app 700 displays in a pop-up form on a preview screen 1400 when the cutting machine 103 is detected in step S1102 and the device information is acquired from the cutting machine 103 detected in step S1103. On the setting screen 1410, the device name “cutting machine A” of the cutting machine 103 is displayed in a display field 1404, and on the basis of the device information, the paper sizes A4 and A3 that can be cut by the cutting machine 103 are displayed in a user-selectable manner. Thereafter, when one of the paper sizes A4 and A3 displayed on the setting screen 1410 is selected by the user and a “reflect” button 1420 is pressed, the information (paper size) set by the user on the setting screen 1410 is reflected to the information to be transmitted to the cutting machine 103, the setting screen 1410 is closed, and the processing proceeds to the next step S1104. It should be noted that an “execute” button 1430 cannot be pressed by the user at this time.

Returning to FIG. 11A, the display processing part 701 displays, on the preview screen 1400, a display field 1413 for the user to insert an image to be cut, set the cutting region, and the like, and the input processing part 702 receives a user input based on the preview screen 1400 (step S1104: setting unit). The input processing part 702 transmits each data input by the user to the image processing part 704 and the like, and each functional part to which the data is transmitted reflects the contents of the user input. FIG. 14B shows the preview screen 1400 including the display field 1413 whose display is updated in accordance with the operation received in step S1104. In FIG. 14B, in addition to the display field 1413, a cutting region designation formats 1408 to 1411 (giving unit) and a cutting region 1414 designated by the user are displayed on the preview screen 1400. That is, in the present embodiment, an image to be cut is preview-displayed in the display field 1413 in advance, and when the designation format 1411 is selected by the user, the size and position of the cutting region defined by a star-shaped cutting line are set by the user on the display field 1413. However, the configuration is not limited thereto as long as the shape, size, and position of the cutting region are set by the user in step S1104. For example, in a case where the designation format 1408 is selected by the user, the cutting region is set as a cutting region defined by a handwritten cutting line by the user on the display field 1413. In addition, in a case where a designation format 1409 is selected by the user, the size and position of the cutting region defined by the round cutting line are set by the user on the display field 1413. In addition, in a case where the designation format 1410 is selected by the user, the size and position of the cutting region defined by the rectangular cutting line are set by the user on the display field 1413. In addition, in a case where a designation format 1412 is selected by the user, the contour of the image to be cut is automatically recognized as a cutting line, and the cutting region is set according to the automatic recognition result. In addition, in a case where the user does not set the cutting region, the cuttable region is set as the cutting region.

Returning to FIG. 11A, subsequently, when a “cut & print” tab 1402 is pressed by the user on the preview screen 1400 and the input processing part 702 receives an instruction to print an image to be cut (step S1105), the processing proceeds to step S1106.

In step S1106, the device registration part 705 detects the image forming apparatus 101, and the display processing part 701 redisplays the setting screen 1410 in a pop-up format on the display field 1413 of the preview screen 1400. FIG. 14C shows the setting screen 1410 redisplayed by the display processing part 701 of the cutting app 700 when the image forming apparatus 101 is detected in step S1106. On the redisplayed setting screen 1410, the device name “printer B” of the detected image forming apparatus 101 is displayed in a display field 1405.

Returning to FIG. 11A, next, the input processing part 702 receives various print settings from the user on the setting screen 1410 redisplayed in step S1106 (step S1107). On the setting screen 1410 shown in FIG. 14C, as one of the print settings, a paper to be printed (A4 in this example) is selected. In addition, although not illustrated on the setting screen 1410 shown in FIG. 14C, in step S1107, the setting of the presence or absence of printing of a trim mark image, the paper feed tray of the image forming apparatus 101, and the like may be received. When the reception of various print settings is completed in step S1107, the “execute” button 1430 can be pressed by the user.

Returning to FIG. 11A, next, when the input processing part 702 receives a print execution instruction by pressing the “execute” button 1430 on the setting screen 1410 from the user (step S1108), the processing proceeds to step S1109.

In step S1109, the image processing part 704 determines whether or not the image to be printed falls within the cuttable region of the cutting machine 103. If the image does not fall within the cuttable region (NO in step S1109), the display processing part 701 displays a warning message (step S1110: warning notification unit). Here, “return to image editing” and “continue printing as it is” are displayed as warning messages in a user-selectable manner. If the user selects “return to image editing” in the warning message (Yes in step S1122), the processing returns to step S1104. On the other hand, if the user selects “continue printing as it is” in the warning message (No in step S1122), the image processing part 704 performs the processing of step S1111 and subsequent steps.

First, in step S1111, the trimming setting, which will be described later with reference to FIG. 13, stored in advance in the storage 604 is acquired (second acquisition unit). In the present embodiment, a case where the trimming setting is stored in the storage 604 in advance will be described, but the present invention is not limited thereto. For example, in a case where the trimming setting cannot be acquired from the storage 604 in step S1111, the cutting app 700 may display a trimming setting screen 1301 (FIG. 13) to allow the user to select the trimming setting.

Next, in step S1112, it is determined whether the acquired trimming setting is “a trimming printing is not performed” or “a trimming printing is performed”. When the acquired trimming setting is “a trimming printing is not performed” (No in step S1112), a print image is generated without being trimmed (step S1121), and the processing proceeds to step S1117. On the other hand, when the acquired trimming setting is “a trimming printing is performed” (Yes in step S1112), the processing proceeds to step S1113.

In step S1113, it is determined whether a trimming boundary (cutting region) is defined by a cuttable region or a cutting line in the acquired trimming setting. In a case where the trimming boundary is defined by the cuttable region (Yes in step S1113), a print image trimmed along the cuttable region is generated (step S1118: print image generation unit), and the processing proceeds to step S1117. On the other hand, in a case where the trimming boundary is defined by the cutting line (No in step S1113), the processing proceeds to step S1114.

In step S1114, it is determined whether or not there is a margin setting in the acquired trimming setting. In a case where there is no margin setting (No in step S1114), the processing proceeds to step S1115. On the other hand, in a case where there is the margin setting (Yes in step S1114), the set margin is given to the inside of the cutting line to generate the print image (step S1119: print image generation unit), and the processing proceeds to step S1117. By generating the print image in which the margin is given to the inside of the cutting line in this manner, it is possible to leave room for the user to rework in a case where the cutting machine 103 cannot cut along the cutting line.

In step S1115, it is determined whether or not there is a protrusion setting in the acquired trimming setting. In a case where there is no protrusion setting (No in step S1115), the print image trimmed with the cutting line is generated (step S1116), and the processing proceeds to step S1117. On the other hand, in a case where there is the protrusion setting (Yes in step S1115), a fixed amount of protrusion of the image is given to the outside of the cutting line to generate the print image (step S1120: print image generation unit), and the processing proceeds to step S1117. By generating the print image in which the protrusion of the image is given to the outside of the cutting line in this manner, it is possible to leave room for the user to rework in a case where the cutting machine 103 cannot cut the image along the cutting line. In the present embodiment, in a case where there is no margin setting in the acquired trimming setting, it is determined whether or not there is a protrusion setting, but the order of determination may be reversed, or only one setting may be settable.

In step S1117, after the generation of the print image is completed (steps S1116, S1118, S1119, S1120, and S1121), print data is generated on the basis of the generated print image, and a print execution instruction is transmitted to the image forming apparatus 101 together with the print data (step S1117). Thereafter, this processing ends.

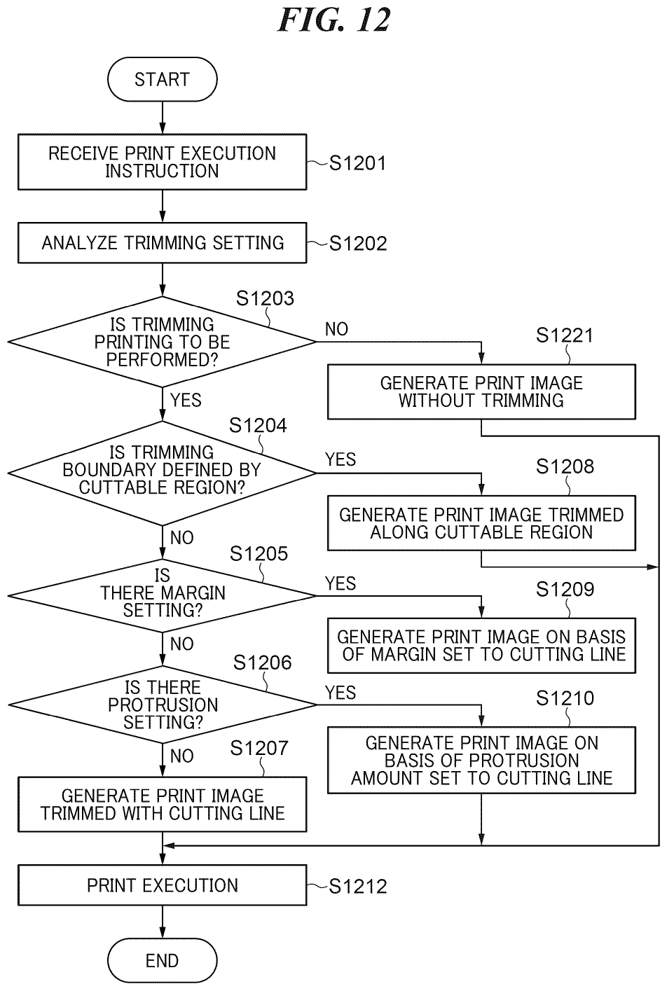

FIG. 12 is an example of a flowchart of processing executed by the image forming apparatus 101 when printing a target to be cut. Here, FIG. 12 is a flowchart for describing in more detail the processing using the OS 310 executed by the CPU 201 of the image forming apparatus 101 in the sequence of FIG. 9. It should be noted that this processing does not proceed to step S1111 after the processing of FIG. 11A ends, and is started after the image processing part 704 of the cutting app 700 transmits a print execution instruction to the image forming apparatus 101 together with the image to be cut, the cuttable region, and the trimming setting.

When the CPU 201 receives the print execution instruction together with the image to be cut, the cuttable region, and the trimming setting from the cutting app 700 (step S1201: acquisition unit), the CPU 201 performs the processing of step S1202 and subsequent steps. The CPU 201 cooperates with the job control unit 331 and the cutting information processing unit 337 to execute the processing of step S1202 and subsequent steps. In the present embodiment, a case where the trimming setting is transmitted together with the print execution instruction will be described, but the present invention is not limited thereto. For example, in a case where the trimming setting has not been transmitted together with the print execution instruction received in step S1201, the trimming setting screen 1301 (FIG. 13) may be displayed in the image forming apparatus 101 to allow the user to select the trimming setting.

First, in step S1202, the trimming setting received together with the print execution instruction in step S1201 is analyzed (step S1202).

Next, in step S1203, on the basis of the analysis result of step S1202, it is determined whether the trimming setting is “a trimming printing is not performed” or “a trimming printing is performed”. In a case where the acquired trimming setting is “a trimming printing is not performed” (No in step S1203), a print image is generated without trimming (step S1221), and the processing proceeds to step S1212. Here, the print image data generation is performed in cooperation with the image generation unit 338, the printer image processing unit 290, and the cutting information processing unit 337. On the other hand, in a case where the acquired trimming setting is “a trimming printing is performed” (Yes in step S1203), the processing proceeds to step S1204.

Next, in step S1204, on the basis of the analysis result of step S1202, it is determined whether the trimming boundary (cutting region) is defined by the cuttable region or the cutting line. In a case where the trimming boundary is defined by the cuttable region (Yes in step S1204), a print image trimmed along the cuttable region is generated (step S1208: print image generation unit), and the processing proceeds to step S1212. On the other hand, in a case where the trimming boundary is defined by the cutting line (No in step S1204), the processing proceeds to step S1205.

In step S1205, on the basis of the analysis result of step S1202, it is determined whether or not there is a margin setting. In a case where there is no margin setting (No in step S1205), the processing proceeds to step S1206, and it is determined whether or not there is a protrusion setting. On the other hand, in a case where there is the margin setting (Yes in step S1205), the set margin is given to the inside of the cutting line to generate the print image (step S1209: print image generation unit), and the processing proceeds to step S1212. By generating the print image in which the margin is given to the inside of the cutting line in this manner, it is possible to leave room for the user to rework in a case where the cutting machine 103 cannot cut along the cutting line. In the present embodiment, in a case where there is no margin setting in the acquired trimming setting, it is determined whether or not there is a protrusion setting, but the order of determination may be reversed, or only one setting may be settable.

In step S1206, it is determined whether or not there is a protrusion setting in the acquired trimming setting. In a case where there is no protrusion setting (No in step S1206), the print image trimmed with the cutting line is generated (step S1207), and the processing proceeds to step S1212. On the other hand, in a case where there is the protrusion setting (Yes in step S1206), the protrusion amount set to the cutting line is given to generate the print image (step S1210: print image generation unit), and the processing proceeds to step S1212. By generating the print image in which the protrusion amount is given to the outside of the cutting line in this manner, it is possible to leave a room for the user to rework in a case where the cutting machine 103 cannot cut along the cutting line.

In step S1212, after the generation of the print image is completed (steps S1207, S1208, S1209, S1210, and S1221), print data is generated on the basis of the generated print image, and the print data is transmitted to the printer 295 via the device I/F 220 to perform printing. Thereafter, this processing ends.

FIG. 13 is a diagram showing the trimming setting screen 1301. The trimming setting using the trimming setting screen 1301 is performed in advance before the processing of FIGS. 11A and 11B, and is held in the storage 604. As described above, the trimming setting screen 1301 is displayed by at least one of the cutting app 700 and the image forming apparatus 101.

On the trimming setting screen 1301, various menus 1302 to 1307 for performing trimming setting of the image to be cut are displayed in a user-selectable manner.

In a case where the user selects the menu 1302 for setting “a trimming printing is not performed” as the trimming setting, the other menus are grayed out.

In a case where the user selects a menu 1303 for setting “a trimming printing is performed” as the trimming setting, the trimming boundary is set by the user using one of menus 1304 and 1305. Specifically, in a case where the user selects the menu 1304 for setting “an image outside cuttable region is not printed” as the trimming setting, the trimming boundary is set as the cuttable region. In addition, in a case the user selects the menu 1305 for setting “an image outside cutting line is not printed” as the trimming setting, the trimming boundary is set to the cutting line.

In addition, in a case where the menu 1305 is selected by the user, the user can further set the margin amount or the protrusion amount with respect to the cutting line. Specifically, in a case where the user selects a menu 1306 for setting “a margin is given inside the cutting line” as the trimming setting, the margin width (5 mm in the example of FIG. 13) input by a numerical value input unit 1306a in the menu 1306 is set inside the cutting line. As shown in FIG. 13, for example, the margin width of 5 mm is set here. In addition, in a case where the user selects a menu 1307 for setting “a fixed amount of image is printed outside the cutting line (protrusion printing)” as the trimming setting, the protrusion amount input by a numerical value input unit 1307a in the menu 1307 is set outside the cutting line. As shown in FIG. 13, for example, a protrusion amount of 5 mm is set here.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-010797, filed Jan. 29, 2024 which is hereby incorporated by reference herein in its entirety.

What is claimed is:

1. An information processing system including an image forming apparatus configured to print a print image on a medium, an information processing apparatus, and a cutting machine, the information processing system comprising:
at least one memory and at least one processor which function as:
a setting unit configured to set a cutting region in which the cutting machine cuts the medium on which the print image has been printed; and
a print image generation unit configured to generate, from an input image, the print image not including an image outside a cutting region.

2. The information processing system according to claim 1, wherein the at least one memory and the at least one processor further function as:
a first acquisition unit configured to acquire a cuttable region of the cutting machine; and
a warning notification unit configured to notify a warning in a case where the cutting region does not fall within the cuttable region.

3. The information processing system according to claim 1, wherein the at least one memory and the at least one processor further function as:
a second acquisition unit configured to acquire a setting related to printing of the input image,
wherein the setting unit sets the cutting region on a basis of the setting acquired by the second acquisition unit.

4. The information processing system according to claim 3, wherein, in a case where the setting acquired by the second acquisition unit is a setting in which an image outside the cuttable region is not to be printed, the setting unit sets the cuttable region as the cutting region.

5. The information processing system according to claim 3, wherein the at least one memory and the at least one processor further function as:
a giving unit configured to give a cutting line to an image to be cut according to a user operation,
wherein, in a case where the setting acquired by the second acquisition unit is a setting in which an image outside of the cutting line is not to be printed, the setting unit sets inside of the cutting line as the cutting region.

6. The information processing system according to claim 5, wherein, in a case of setting inside of the cutting line as the cutting region, the setting unit sets a margin inside of the cutting line according to a user operation.

7. The information processing system according to claim 5, wherein, in a case of setting outside of the cutting line as the cutting region, the setting unit gives a fixed amount of image protrusion to outside of the cutting line according to a user operation.

8. A non-transitory computer readable storage medium storing a cutting application that causes an information processing apparatus to cooperates with an image forming apparatus configured to print a print image on a medium and a cutting machine, the cutting application comprising code for executing:
setting of a cutting region in which the cutting machine cuts the medium on which the print image has been printed; and
generating of the print image not including an image outside a cutting region from an input image.

9. The non-transitory computer readable storage medium according to claim 8, wherein the cutting application further comprising code for executing:
acquiring of a cuttable region of the cutting machine; and
notifying of a warning in a case where the cutting region does not fall within the cuttable region.

10. The non-transitory computer readable storage medium according to claim 8, wherein the cutting application further comprising code for executing:
acquiring of a setting related to printing of the input image, and
setting of the cutting region by the setting based on the acquired setting.

11. The non-transitory computer readable storage medium according to claim 10, wherein the cutting application further comprising code for executing:
in a case where the acquired setting is a setting in which an image outside the cuttable region is not to be printed, setting of the cuttable region as the cutting region by the setting.

12. The non-transitory computer readable storage medium according to claim 10, wherein the cutting application further comprising code for executing:
giving of a cutting line corresponding to a user operation to an image to be cut, and
in a case where the acquired setting is a setting in which an image outside of a cutting line is not to be printed, setting of inside of the cutting line as the cutting region by the setting.

13. The non-transitory computer readable storage medium according to claim 12, wherein the cutting application further comprising code for executing:
in a case where inside of the cutting line is set as the cutting region by the setting, setting of a margin inside of the cutting line according to a user operation.

14. The non-transitory computer readable storage medium according to claim 12, wherein the cutting application further comprising code for executing:
in a case where outside of the cutting line is set as the cutting region by the setting, giving of a fixed amount of image protrusion to outside of the cutting line according to a user operation.

15. An image forming apparatus connected to an information processing apparatus and a cutting machine and configured to print a print image on a medium, the image forming apparatus comprising:
at least one memory and at least one processor which function as:
an acquisition unit configured to acquire, from the information processing apparatus, a cutting region in which the cutting machine cuts a medium on which the print image has been printed; and
a print image generation unit configured to generate, from an input image, the print image not including an image outside a cutting region.

16. The image forming apparatus according to claim 15, wherein the at least one memory and the at least one processor further function as:
a second acquisition unit configured to acquire a setting related to printing of the input image, wherein
the setting unit sets the cutting region on a basis of the setting acquired by the second acquisition unit.

17. The image forming apparatus according to claim 16, wherein
in a case where the setting acquired by the second acquisition unit is a setting in which an image outside the cuttable region is not to be printed, the setting unit sets the cuttable region as the cutting region.

18. The image forming apparatus according to claim 16, wherein the at least one memory and the at least one processor further function as:
a giving unit configured to give a cutting line to an image to be cut according to a user operation, wherein
in a case where the setting acquired by the second acquisition unit is a setting in which an image outside of the cutting line is not to be printed, the setting unit sets inside of the cutting line as the cutting region.

19. The image forming apparatus according to claim 18, wherein
in a case of setting inside of the cutting line as the cutting region, the setting unit sets a margin inside of the cutting line according to a user operation.

20. The image forming apparatus according to claim 18, wherein
in a case of setting inside of the cutting line as the cutting region, the setting unit gives a fixed amount of image protrusion to outside of the cutting line according to a user operation.
